(19) United States
(12) Patent Application Publication
(10) Pub. No.: US 2015/0169122 A1
(43) Pub. Date: Jun. 18, 2015

(54) METHOD FOR OPERATING A MULTI-TOUCH-CAPABLE DISPLAY AND DEVICE HAVING A MULTI-TOUCH-CAPABLE DISPLAY

(71) Applicant: Bauhaus-Universitat Weimar, Weimar (DE)

(72) Inventors: Alexander Kulik, Dresden (DE); Bernd Fröhlich, Weimar (DE); Jan Dittrich, Weimar (DE)

(21) Appl. No.: 14/367,865

(22) PCT Filed: Dec. 11, 2012
(86) PCT No.: PCT/EP2012/075034

§ 371 Date: Jun. 20, 2014

(30) Foreign Application Priority Data
Dec. 22, 2011 (DE) 102011056940.5

(51) Int. Cl. G06F 3/041; G06F 3/0481

(52) U.S. Cl. CPC G06F 3/0412; G06F 3/0481; G06F 2203/04106

(57) ABSTRACT

The invention relates to a method for operating a multi-touch-capable display and to a device having computer functionality. In one step of the method, contents that can be manipulated are shown on the display. The contents comprise hierarchically structured interaction objects of two hierarchy levels. In further steps, a first touch and a second touch of the display are detected, which leads to information about said touches. The information about the first touch is used to manipulate interaction objects of the first hierarchy level. According to the invention, the information about the second touch is used to manipulate interaction objects of the second hierarchy level if the second touch is detected more than a certain length of time after the first touch and the first touch is still detected. In contrast, the information about the second touch is used to manipulate interaction objects of the first hierarchy level if the second touch is detected not more than the certain length of time after the first touch.

### FIELD OF THE INVENTION

The present invention relates to a method for operating a multi-touch-capable display, such as a multi-touch-capable touchscreen, which can be operated using two of the user's fingers. The invention further relates to a device having computer functionality, which comprises a multi-touch-capable display.

### BACKGROUND OF THE INVENTION

U.S. 2010/0328227 A1 shows a multi-finger mouse emulation, by way of which a computer mouse having multiple mouse buttons is simulated on a touchscreen.

DE 20 2006 020 369 U1 shows a multi-functional hand-held device, in which a distinction is made between light and hard touches with regard to the input gestures.

U.S. 2011/0041096 A1 shows the manipulation of graphical elements via gestures. It allows the selection in menus having multiple hierarchy levels using two-hand operation.

A method for operating touch-sensitive interfaces is known from U.S. 2011/0216095 A1, in which a distinction is made whether one or two contacts are made with the touch-sensitive interface within a predetermined time period.

U.S. 2011/0227947 A1 shows a multi-touch user interface, including a multi-touch-capable mouse.

U.S. Pat. No. 6,958,749 B1 describes a method for operating a touch panel, in which an illustrated object is shifted using a finger. If contact with the touch panel is made by two fingers, the object is rotated.

U.S. Pat. No. 8,004,498 B1 shows a method for temporarily anchoring a portion of a graphical object on a touch pad. For this purpose, a hand of the user generates a locking signal for a portion of a graphical element as a function of the duration of the contact, while the other hand can edit a second portion of the graphical element by way of a stylus.

WO 2009/088561 A1 shows a method for a two-hand user interface having gesture detection. The gestures are detected by way of a camera.

WO 2005/114369 A2 shows a touchscreen that can be operated with multiple fingers.

A method for detecting gestures on touch-sensitive input devices is known from WO 2006/020305 A2. In one embodiment of this method, illustrated objects can be scaled by way of two fingers. In a further embodiment, a switch between modes can be made by way of a thumb, while objects can be moved at the same time using another finger.

DE 21 2008 000 001 U1 shows a device for scrolling lists and for translating, scaling and rotating documents on a touchscreen display. The touchscreen display is to be operated with two fingers for rotating and scaling the illustrated content.

DE 20 2008 001 338 U1 shows a multi-point sensing device, by way of which multiple gestures can be detected.

DE 20 2005 021 492 U1 shows an electronic device having a touch-sensitive input unit, in which gestures are detected so as to display new media objects.

WO 2009/100421 A2 shows a method for manipulating objects on a touchscreen. In this method, the relative position between a first touch and a second touch is evaluated.

WO 2011/107839 A1 shows a method for carrying out drag and drop inputs on multi-touch-sensitive displays. FIGS. 3A to 3G of WO 2011/107839 A1 illustrate the operation of contact lists. Individual contacts are used to change positions on the list or select individual entries. Contacts with two fingers are used for drag and drop, wherein objects on two hierarchy levels are manipulated simultaneously. A criterion for detecting two contacts is that the two touches overlap in time. The expiration of a particular time period thus does not constitute a criterion. For example, two immediately following double inputs using two fingers result in drag and drop. A double input using two fingers always results in the drag-and-drop mode, so that a manipulation of an individual interaction object (such as zoom) or of two interaction objects of the same hierarchy level by two simultaneous contacts is not possible.

Proceeding from the prior art, it is the object of the present invention to facilitate the input of information on a multi-touch-capable display and to bring it in line with experiences that are made in physical reality.

### SUMMARY OF THE INVENTION

The aforementioned object is achieved by a method for operating a multi-touch-capable display according to the accompanying claims 1 and 9 and by a device having computer functionality according to the accompanying claim 10.

A first subject matter of the invention is formed by a method for operating a multi-touch-capable display that is controlled by a data processing unit, such as a multi-touch-capable touchscreen in the form of a touchscreen of a tablet PC. The multi-touch-capable display can alternatively also be formed by a two- or three-dimensional projection unit having data input devices, such as data gloves or 3D mice, wherein direct contact of the data input devices results in virtual contact with the illustrated content. The method according to the invention is used in particular to evaluate gestures when operating the multi-touch-capable display and to adapt representations to the multi-touch-capable display.

In one step of the method according to the first subject matter of the invention, content that can be manipulated is visually represented on or within the display. The content comprises hierarchically structured interaction objects. The interaction objects are characterized in that the visual representation thereof can be touched directly or indirectly on or within the multi-touch-capable display so as to modify the interaction objects. For example, the contact is carried out on a touchscreen directly via the visual representation. In contrast, if the multi-touch-capable display is a projection device having data gloves, a contact is carried out within the data gloves, resulting in virtual contact with the illustrated interaction objects. The interaction objects are hierarchically structured, so that there are lower-level interaction objects and higher-level interaction objects. At least interaction objects of a first hierarchy level and of a second hierarchy level are present.

In a further step of the method according to the invention, a first touch of the multi-touch-capable display made by the operator is detected, which results in information about the first touch which can be processed by the data processing unit. This information is used to manipulate interaction objects of the first hierarchy level. In a further step, a second touch of the multi-touch-capable display is detected, which results in information about the second touch which can be processed by the data processing unit. The second touch is characterized in that the location thereof differs from that of the first touch, whereby a conclusion can be drawn that this second touch was made by a second object, such as by a second finger of the operator. According to the invention, the information about the second touch is used by the data processing unit to manipulate interaction objects of the second hierarchy level if the second touch is detected more than a predetermined time period after the first touch and the first touch is still detected. Waiting the predetermined time period thus serves to detect the user's intention according to which the second touch is to relate to an interaction object of the second hierarchy level, for example an interaction object which is subordinate to the interaction object of the first hierarchy level to be manipulated. In contrast, according to the invention the information about the second touch is used by the data processing unit to manipulate interaction objects of the first hierarchy level if the second touch is detected less than a predetermined time period after the first touch. In this way, two contacts by the user which are made simultaneously or with little time delay are understood to the effect that they are to relate to interaction objects of the same hierarchy level, this being the first hierarchy level, and preferably to the same interaction object of the first hierarchy level.

A particular advantage of the method according to the invention is that interaction objects of different hierarchy levels can be manipulated by the user without requiring additional sensors for this purpose. Undesired changes of the hierarchy levels are nevertheless substantially prevented. The flow of operation is not interrupted when the hierarchy level changes. The change of the hierarchy level does not require any perceptible waiting period. Another advantage of the method according to the invention is that no additional operating elements must be represented on or within the multi-touch-capable display, so that the same is available for the content of further applications. The method according to the invention substantially prevents faulty inputs resulting from vibrations, in particular in the case of touchscreens. The method according to the invention does not conflict with other methods for operating multi-touch-capable displays, so that synchronous inputs in the same hierarchy level can still be carried out, for example. The method according to the invention is preferably independent from the speed of the locally changing touch on or within the multi-touch-capable display, and preferably also independent from the position of the touch on or within the multi-touch-capable display.

The inventive idea is in particular to establish the change from any arbitrary mode for processing one or more interaction objects of a first hierarchy level (such as activating or moving individual interaction objects, zooming an interaction objects) into a mode for processing interaction objects on two hierarchy levels. For this purpose, waiting between the two touches occurs for a predetermined time period. If the time until the second touch is less than the predetermined time period, the mode for processing individual interaction objects in the first level is maintained. It is irrelevant whether or not the first touch is still present. This is because there are some modes that require two simultaneous touches (such as zooming an interaction object). There are also models that necessitate only individual touches (such as activating or moving an interaction object). It is conceivable, for example, that the first touch is still present, or also that the first touch is no longer present, when the second touch begins within the predetermined time period after the first touch. Neither one of these two cases prompts a switch into the mode for manipulating interaction objects at two hierarchy levels by way of two simultaneous touches (such as hold-and-move, see below).

In preferred embodiments of the method according to the invention, the information about the first touch and the information about the second touch is processed in each case according to a first manipulation mode if the information about the second touch is used to manipulate interaction objects of the second hierarchy level. The operator can thus simultaneously manipulate a higher-level interaction object and a lower-level interaction object in the same manner. For example, the operator can displace a lower-level interaction object in relation to a higher-level interaction object by moving both the higher-level interaction object and the lower-level interaction object on or within the multi-touch-capable display.

In further preferred embodiments of the method according to the invention, the information about the first touch and the information about the second touch are processed together according to a second manipulation mode if the information about the second touch is used to manipulate interaction objects of the first hierarchy level. For this purpose, preferably one and the same interaction object is manipulated. The user can consequently use his second finger, for example, to carry out more complex manipulations according to the second manipulation mode on the interaction object of the first hierarchy level if he does not want to use the second finger to carry out manipulations on an interaction object of the second hierarchy level.

In further preferred embodiments of the method according to the invention, the information about the second touch is processed according to the first manipulation mode if the first touch is no longer detected. The user can thus return to the first manipulation mode without interruption after having manipulated an interaction object according to the second manipulation mode by touching the multi-touch-capable display twice.

The first hierarchy level of the interaction objects is preferably directly above the second hierarchy level of the interaction objects. The interaction objects of the first hierarchy level consequently in each case comprise interaction objects of the second hierarchy level.

The interaction objects of the second hierarchy level are preferably elementary so that the second hierarchy level represents the lowest hierarchy level.

The interaction objects of the first hierarchy level are preferably formed by groups, which in each case can comprise the elementary interaction objects of the second hierarchy level.

The interaction objects of the second hierarchy level are preferably formed by symbols (icons), pictograms, images and/or windows. The interaction objects of the first hierarchy level are preferably formed by symbolized folders and/or windows.

In preferred embodiments of the method according to the invention, the illustrated content comprises hierarchically structured interaction objects on more than two hierarchy levels. This is because the method according to the invention is suitable for allowing the operator to carry out an intuitive and fast interaction across multiple hierarchy levels.

The first manipulation mode and the second manipulation mode preferably each specify how, proceeding from the information about the respective touch, the illustrated interaction objects are to be modified. Preferably in each case the interaction object that is manipulated is the one which is visually represented at the site of the particular touch on or within the multi-touch-capable display.

For example, manipulation of elementary interaction objects of the second hierarchy level according to the first manipulation mode allows the interaction object that is to be manipulated to be assigned to another one of the groups of the first hierarchy level.

Preferably in each case the group of the first hierarchy level that is manipulated is the one which is visually represented at the site of the first touch on or within the multi-touch-capable display.

The interaction objects are preferably modified directly after the first touch has been detected or directly after the second touch has been detected. The interaction objects are preferably modified concurrently with local modifications of the detected first touch or of the detected second touch.

In preferred embodiments of the method according to the invention, the operator is made available functions by the first manipulation mode which allow him to navigate the content represented by the display. The first manipulation mode thus preferably results in the activation of the interaction object of the first hierarchy level represented on or within the multi-touch-capable display which is represented on or within the multi-touch-capable display at the site where the first touch is detected for the first time or at which the first touch is directed during the first-time detection. At the same time, all the remaining interaction objects of the first hierarchy level which are represented by the display are preferably passivated. Similarly, the first manipulation mode preferably results in the activation of the interaction object of the second hierarchy level represented by the display which is represented on or within the multi-touch-capable display at the site where the second touch is detected for the first time, or at which the second touch is directed during the first-time detection, if the information about the second touch is used to manipulate interaction objects of the second hierarchy level. The first manipulation mode preferably continues to result in the movement of the activated interaction object in accordance with the movement of the respective touch on or within the multi-touch-capable display. If the information of the second touch is used to manipulate interaction objects of the second hierarchy level, which is to say if the operator carried out the second touch more than the predetermined time period after the first touch, the operator can simultaneously move a higher-level interaction object and a lower-level interaction object so as to move these, for example, relative toward each other on or within the multi-touch-capable display. The operator can also maintain the site of the first touch, so that the location of the interaction object of the first hierarchy level is not modified, while the user moves the interaction object of the second hierarchy level. The method according to the invention thus allows the operator to use a hold and move metaphor for inputting data.

The second manipulation mode preferably results in the modification of the interaction object represented at the site of the respective touch on or within the multi-touch-capable display in accordance with the movement of the respective touch on or within the multi-touch-capable display. The second manipulation mode particularly preferred results in scaling or in rotation of the interaction object represented at the site of the respective real or virtual contact.

During the first manipulation mode, the information of an individual touch is preferably applied to the interaction object to be manipulated. In contrast, the information of the two touches are preferably applied to the same single interaction object in the second manipulation mode. The information of the two touches is preferably processed in relation to each other.

The touches are preferably carried out by individual fingers of the operator; alternatively, the touches can also be carried out by hands or by styluses employed by the user. If the display is formed by a touchscreen, the touches are made on the surface of the touchscreen. If the display is formed by a projection unit having data input devices, such as data gloves or 3D mice, the direct touches are carried out on or in the data input devices, wherein the position and/or orientation of the data input devices in relation to the represented content determine the interaction object with which virtual contact is made.

The information ascertained during detection of the touches preferably describes the site of the touch on the display formed by a touchscreen, and further preferably also the change of the site of the touch on the touchscreen over time.

The predetermined time period preferably ranges between 10 ms and 3 s, further preferably between 20 ms and 1 s, and particularly preferably between 50 ms and 200 ms. In addition, the predetermined time period is particularly preferably 100 ms±20 ms.

The multi-touch-capable display is preferably formed by a multi-touch-capable touchscreen, such as by a touchscreen of a tablet PC.

A second subject matter of the invention is again a method for operating a multi-touch-capable display controlled by a data processing unit. This method has the same fields of application as the method according to the first subject matter of the invention.

In one step of the method according to the second subject matter of the invention, content is visually represented on or within the multi-touch-capable display. This content can be manipulated by the data processing unit according to a first manipulation mode, and alternatively according to a second manipulation mode. The first manipulation mode is different from the second manipulation mode. In a further step, a first touch of the multi-touch-capable display carried out by the operator is detected, which results in information about the first touch that can be processed by the data processing unit. In a further step, a second touch of the multi-touch-capable display is detected, which results in information about the second touch that can be processed by the data processing unit.

According to the invention, the information about the first touch and the information about the second touch is processed in each case according to the first manipulation mode for manipulating the content to be manipulated if the second touch is detected more than a predetermined time period after the first touch and the first touch is still detected. In contrast, the information about the first touch and the information about the second touch are processed according to the second manipulation mode for manipulating the content to be manipulated if the second touch is detected less than a predetermined time period after the first touch and the first touch is preferably still detected.

The method according to the second subject matter of the invention allows fast and intuitive switching between two manipulation modes. The inventive idea is in particular to establish the change from a first manipulation mode (such as hold and move) to a second manipulation mode (such as activating or moving individual interaction objects, zooming an interaction object), and vice versa. For this purpose, waiting between the two touches occurs for a predetermined time period. If the time until the second touch is less than the predetermined time period, a switch is made to the second manipulation mode. It is irrelevant whether or not the first touch is still present. There are examples for the second manipulation mode that require two simultaneous contacts (such as zooming an interaction object). There are also examples for the second manipulation mode that necessitate only individual contacts (such as activating or moving an interaction object). It is conceivable, for example, that the first touch is still present, or also that the first touch is no longer present, when the second touch begins within the predetermined time period after the first touch. Neither one of these two cases results in the first manipulation mode, which essentially requires two simultaneous contacts.

The represented content preferably comprises interaction objects. The interaction objects are preferably hierarchically structured.

The information about the first touch is preferably used to manipulate interaction objects on a first of the hierarchy levels.

The information about the second touch is preferably used to manipulate interaction objects on a second of the hierarchy levels if the information about the second touch is processed according to the first manipulation mode.

The information about the second touch is preferably used to manipulate interaction objects on the first hierarchy level if the information about the second touch is processed according to the second manipulation mode.

In addition, according to the second subject matter of the invention, the method according to the invention preferably also comprises those features that are described as preferred for the method according to the first subject matter of the invention.

The device according to the invention has computer functionality and is formed by a smart phone or by a computer, such as a tablet PC, for example. The device comprises a multi-touch-capable display for visually representing content and for detecting touches carried out by the operator. The multi-touch-capable display is preferably formed by a multi-touch-capable screen. Such touchscreens are also referred to as multi-touch screens or tactile screens. As an alternative, the display can also be formed by a two- or three-dimensional projection unit having data input devices, such as data gloves or 3D mice. The device according to the invention moreover comprises a data processing unit, which is configured to carry out the method according to the invention according to the first or according to the second subject matter of the invention. The data processing unit is preferably configured to carry out preferred embodiments of the method according to the invention.

Further advantages, details, and refinements of the invention will be apparent from the following description of various sequences of the method according to the invention, with reference to the drawings.

### BRIEF DESCRIPTION OF THE DRAWINGS

FIG. 1 shows a first sequence according to a preferred embodiment of the method according to the invention;

FIG. 2 shows a second sequence of the embodiment shown in FIG. 1;

FIG. 3 shows a third sequence of the embodiment shown in FIG. 1; and

FIG. 4 shows a state transition diagram of a preferred embodiment of the method according to the invention.

### DETAILED DESCRIPTION

FIG. 1 shows a first sequence of a preferred embodiment of the method according to the invention. Shown are four points in time T1, T2, T3, T4 during the operation of a multi-touch-capable touch screen 01 by way of the left hand 02 and the right hand 03 of an operator. The multi-touch-capable touchscreen 01 can be the touchscreen of a tablet PC, for example.

Individual symbols 04, which are grouped within a window 06, are visually represented on the touchscreen 01. The symbols 04 and the window 06 can be manipulated seemingly directly by touching of the touchscreen 01 and thus represent interaction objects. Since the symbols 04 are grouped within the window 06, the symbols 04 and the window 06 form a hierarchical structure in which the symbols 04 form a lower hierarchy level and the window 06 forms a higher hierarchy level.

At the point in time T1, the operator touches the touchscreen 01 by way of a first finger 07 of his left hand 02 in a region where the window 06 is represented. This singular touch causes the window 06 to be activated in terms of the property thereof as an interaction object of the higher hierarchy level. It is irrelevant what symbol 04, which is to say what interaction object of the lower hierarchy level, is represented at the site of contact by the first finger 07.

By the point in time T2, the operator has moved the first finger 07 of his left hand 02 on the multi-touch screen 01 downward to the illustrated position. The window 06 having the symbols 04 illustrated therein was similarly moved downward, following the detected movement of the first finger 07. The activation of the window 06 and the movement of the window 06 are manipulations according to a first manipulation mode. The first manipulation mode comprises in particular functions that allow navigation in the represented content.

By the point in time T3, the operator has ended the touch of the multi-touch screen 01 by way of the first finger 07 of his left hand 02, and has instead touched the touchscreen 01 by way of a second finger 08 of his right hand 03 at the illustrated position. The touching of the touchscreen 01 is again carried out in a region in which the window 06 is represented. It is again irrelevant what symbol 04 is represented at the site of contact. Since the touchscreen 01 is again operated by way of a singular touch, the information about the touch is likewise processed according to the first manipulation mode. This contact thus also reactivates the window 06, which is moved to a position that is shown for the point in time T4 by way of a movement of the second finger 08 on the touchscreen 01.

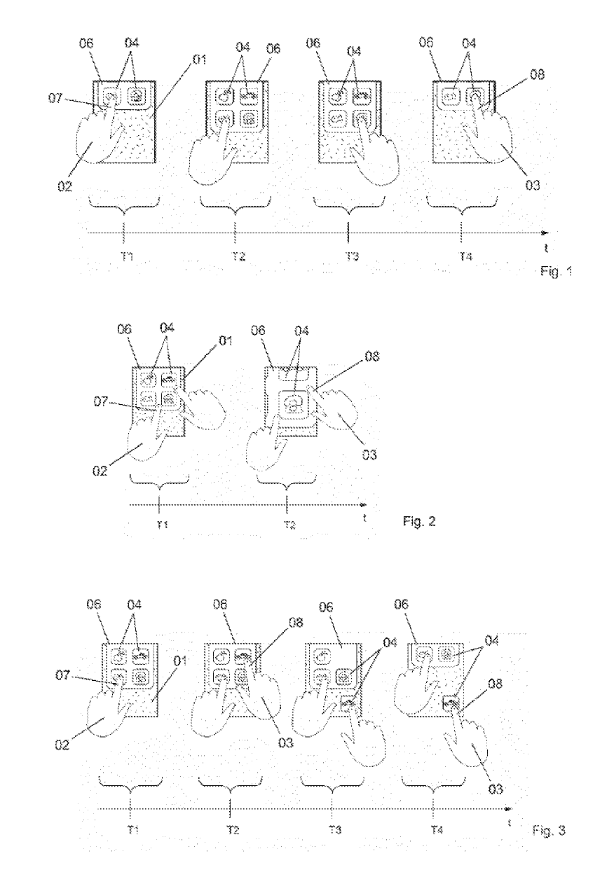

FIG. 2 shows a second sequence of the preferred embodiment of the method according to the invention. At the shown point in time T1, the operator has touched the touchscreen 01 almost simultaneously by way of the first finger 07 of his left hand 02 and the second finger 08 of his right hand 03. In any case, the touch by way of the first finger 07 and the touch by way of the second finger 08 were made with little time delay, which is less than a predetermined time period of 100 ms, for example. This simultaneity intended by the operator causes the touch by way of the first finger 07 and the touch by way of the second finger 08 to be evaluated according to a second manipulation mode. The second manipulation mode in this embodiment provides for both touches to be applied to the window 06. Both touches are thus applied to the same interaction object of the higher hierarchy level.

By the point in time T2, the operator has moved the first finger 07 of his left hand 02 and the second finger 08 of this right hand 03 on the touchscreen 01 in such a way that the distance between the sites of the two touches is larger than at the point in time T1. According to the second manipulation mode, the window 06 is scaled, so that it is represented in a larger format at the point in time T2.

FIG. 3 shows a further sequence of the preferred embodiment of the method according to the invention. At the shown point in time T1, the operator has touched the touchscreen 01 by way of the first finger 07 of his left hand 02 in the region of the window 06. At the point in time T2, the operator has additionally touched the touchscreen 01 by way of the second finger 08 of his right hand 03. Since the two points in time T1 and T2 are more than the predetermined time period of 100 ms, for example, apart, in contrast to the sequence shown in FIG. 2 the two touches are not evaluated according to the second manipulation mode, but are each evaluated according to the first manipulation mode. In contrast to the sequence shown in FIG. 2, the touch by way of the second finger 08 of the right hand 03 is not related to the window 06, but to one of the interaction objects of the lower hierarchy level, which is to say to one of the symbols 04, and more particularly to the symbol 04 which is represented at the site of contact by way of the second finger 08. The two touches by way of the fingers 07, 08 consequently relate to interaction objects 04, 06 of differing hierarchy levels. The two touches by way of the fingers 07, 08 are processed according to the first manipulation mode, so that the interaction objects 04, 06 are activated and subsequently optionally moved.

At the point in time T3, the operator has moved the second finger 08 of his right hand 03 on the touchscreen 01, and more particularly has moved it downward, while he has left the first finger 07 of his left hand 02 unchanged at the same site. The movement of the second finger 08 has caused the activated symbol 04 to be shifted downward by way of the second finger 08, wherein this resulted in the removal of the symbol 04 from the window 06. Since the touch by way of the first finger 07 relates to the window 06, leaving the finger 07 at the selected site causes the window 06 to maintain the position thereof. The sequence shown represents a hold and move metaphor.

By the point in time T4, the operator has also moved the first finger 07 of his left hand 02, which is to say upward, so that the representation of the window 06 was also moved upward on the touchscreen 01. The operator also could have carried out the movements of the first finger 07 and of the second finger 08 in reverse order, or simultaneously, to achieve the state illustrated at the point in time T4.

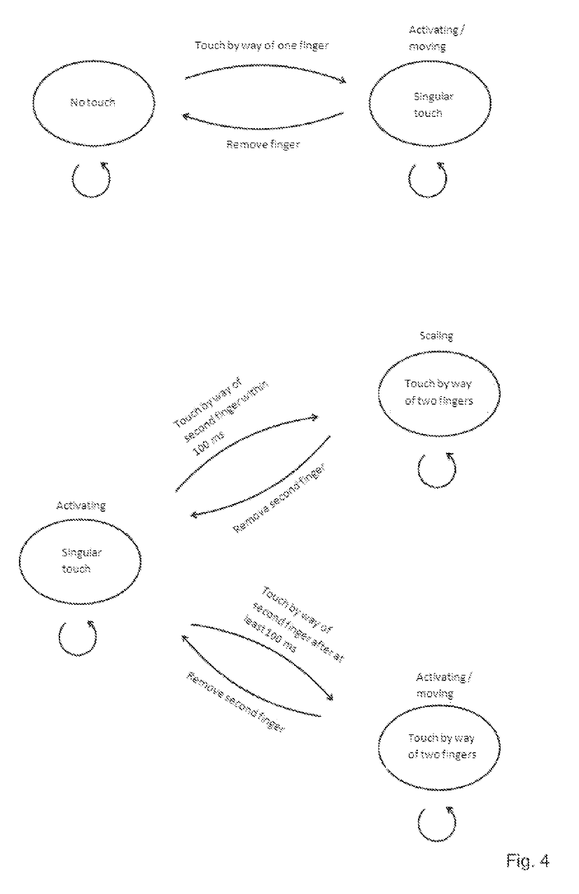

FIG. 4 shows a state transition diagram of a preferred embodiment of the method according to the invention. The upper part of the state transition diagram shows the transition from a “no touch” state into the “singular touch” state. The singular touch of the multi-touch-capable touchscreen 01 (shown in FIG. 1) results in a manipulation of the interaction object of the higher hierarchy level represented at the site of contact according to the first manipulation mode. In this way, the activation and movement of the window 06 shown in FIG. 1 is possible.

The lower part of the state transition diagram shows the transition from the “singular touch” state into a “touch by way of two fingers” state, and conversely, wherein a distinction is made whether this state transition takes place in less or more than 100 ms, for example. If this transition takes place in less than 100 ms, the two touches are jointly applied to the interaction object of the first hierarchy level. The scaling of the window 06 shown in FIG. 2 is carried out as a result of a movement of the two touches.

If the state transition takes place in more than 100 ms, the second touch results in a manipulation of one of the interaction objects of the second hierarchy level, such as the manipulation of the symbol 04, for example (shown in FIG. 3). In this way, a manipulation of two interaction objects according to the “hold and move” metaphor illustrated in FIG. 3 can be carried out.

### LIST OF REFERENCE NUMERALS

01—multi-touch-capable touchscreen
02—left hand
03—right hand
04—symbol
05 ——
06—window
07—first finger
08—second finger

1. A method for operating a multi-touch-capable display that is controlled by a data processing unit, comprising the following steps:
visually representing content that can be manipulated on or within the multi-touch-capable display, the content comprising hierarchically structured interaction objects of at least one first hierarchy level and one second hierarchy level;
detecting a first touch of the multi-touch-capable display, the detection of the first touch resulting in information about the first touch which can be processed by the data processing unit and which can be used by the data processing unit to manipulate interaction objects of the first hierarchy level; and
detecting a second touch of the multi-touch-capable display, the detection of the second touch resulting in information about the second touch which can be processed by the data processing unit;
wherein the information about the second touch is used by the data processing unit to manipulate interaction objects of the second hierarchy level if the second touch is detected more than a predetermined time period after the first touch and the first touch continues to be detected, and the information about the second touch is used by the data processing unit to manipulate interaction objects of the first hierarchy level if the second touch is detected less than the predetermined time period after the first touch.

2. The method according to claim 1, wherein the information about the first touch and the information about the second touch is processed in each case according to a first manipulation mode if the information about the second touch is used to manipulate interaction objects of the second hierarchy level.

3. The method according to claim 1, wherein the information about the first touch and the information about the second touch are processed together by the data processing unit according to a second manipulation mode if the information about the second touch is used to manipulate interaction objects of the first hierarchy level.

4. A method according to claim 1, wherein the interaction objects of the second hierarchy level are elementary.

5. The method according to claim 4, wherein the interaction objects of the first hierarchy level are formed by groups of the elementary interaction objects of the second hierarchy level.

6. A method according claim 1, wherein the interaction objects are formed by symbols, pictograms, images, windows and/or symbolized folders of individual symbols.

7. A method according to claim 1, wherein the first manipulation mode and the second manipulation mode each specify how, proceeding from the information about the respective touch, the represented interaction objects are to be modified.

8. A method according to claim 1, wherein the predetermined time period is between 20 ms and 1 s.

9. A method for operating a multi-touch-capable display that is controlled by a data processing unit, comprising the following steps:
visually representing content on or within the multi-touch-capable display, the content being able to be manipulated by the data processing unit according to a first manipulation mode and according to a second manipulation mode;
detecting a first touch of the multi-touch-capable display, the detection of the first touch resulting in information about the first touch which can be processed by the data processing unit; and
detecting a second touch of the multi-touch-capable display, the detection of the second touch resulting in information about the second touch which can be processed by the data processing unit;
wherein the information about the first touch and the information about the second touch is each processed according to the first manipulation mode if the second touch is detected more than a predetermined time period after the first touch and the first touch is still detected, and the information about the first touch and the information about the second touch are processed according to the second manipulation mode if the second touch is detected less than a predetermined time period after the first touch.

10. A device having computer functionality, comprising:
a multi-touch-capable display for visually representing content and for detecting touches of the multi-touch-capable display; and
a data processing unit, which is configured to carry out the method according to claim 1.

11. The method according to claim 2, wherein the information about the first touch and the information about the second touch are processed together by the data processing unit according to a second manipulation mode if the information about the second touch is used to manipulate interaction objects of the first hierarchy level.

12. A method according to claim 2, wherein the interaction objects of the second hierarchy level are elementary.

13. A device having computer functionality, comprising:
a multi-touch-capable display for visually representing content and for detecting touches of the multi-touch-capable display; and
a data processing unit, which is configured to carry out the method according to claim 2.

14. A device having computer functionality, comprising:
a multi-touch-capable display for visually representing content and for detecting touches of the multi-touch-capable display; and
a data processing unit, which is configured to carry out the method according to claim 3.

15. A device having computer functionality, comprising:
a multi-touch-capable display for visually representing content and for detecting touches of the multi-touch-capable display; and
a data processing unit, which is configured to carry out the method according to claim 4.

16. A device having computer functionality, comprising:
a multi-touch-capable display for visually representing content and for detecting touches of the multi-touch-capable display; and
a data processing unit, which is configured to carry out the method according to claim 5.

17. A device having computer functionality, comprising:
a multi-touch-capable display for visually representing content and for detecting touches of the multi-touch-capable display; and
a data processing unit, which is configured to carry out the method according to claim 6.

18. A device having computer functionality, comprising:
a multi-touch-capable display for visually representing content and for detecting touches of the multi-touch-capable display; and
a data processing unit, which is configured to carry out the method according to claim 7.

19. A device having computer functionality, comprising:
a multi-touch-capable display for visually representing content and for detecting touches of the multi-touch-capable display; and
a data processing unit, which is configured to carry out the method according to claim 8.

20. A device having computer functionality, comprising:
a multi-touch-capable display for visually representing content and for detecting touches of the multi-touch-capable display; and
a data processing unit, which is configured to carry out the method according to claim 9.
